(19) United States
(12) Patent Application Publication
(10) Pub. No.: US 2007/0000812 A1
(43) Pub. Date: Jan. 4, 2007

(54) System for the identification and sorting in a predetermined order of single garments or laundry items

(76) Inventor: Augusto Santicchi, San Sisto (IT)

Correspondence Address: Robert M Gamson;Honson & Brooks, Intellectual Property Law Offices, 502 Washington Avenue Suite 220, Towson, MD, 21204, US

(21) Appl. No.: 10/558,048

(22) PCT Filed: Oct. 5, 2004
(86) PCT No.: PCT/IT04/00550

§ 371 Date: Nov. 22, 2005

(30) Foreign Application Priority Data
Oct. 16, 2003 (IT) MC2003A000124

(51) Int. Cl. B07C 5/02

(52) U.S. Cl. 209/3.3

(57) ABSTRACT

This invention concerns a system for the identification and the sorting in a predetermined order of single garments or laundry items, of the sort that uses a box (1) suitable for reading chips sewn on garments introduced inside the box (1), characterized by the fact that the said box is connected at its top extremity with the straight ascending section (2a) of a large conveying pipe (2), while underneath it has a base (5) with a grating structure (5), associated with a fan (6) suitable for blowing into the box (1) itself a powerful air blast which can give the garments found in the box (1) an upthrust, that enables them to enter the above-mentioned conveying pipe (2) placed above and to pass through its whole length (2a, 2b, 2c) until they are unloaded into suitable bins (c1, c2, c3) placed under the pipe's outlet segment (2c).

This patent application concerns a system for the identification and sorting in a predetermined order of single garments or laundry items.

It is generally known that in large communities such as factories, hospitals, colleges, hotels and the like, the need arises for a fast and efficient service for the washing and distribution of the garments or laundry items belonging to each particular member of the said community.

In order to facilitate this kind of service, the idea of sewing an identification chip on every above-mentioned garment has been used for some time; thanks to this method, the different garments, although they are handled all together and haphazardly during some of the work phases, can be identified one by one and returned to their proper owner.

In this connection, identification boxes already exist, which are used precisely to hold the garments that have to be identified, and in which the corresponding identification devices are placed in order to be able to identify each garment's chip and read its code.

Obviously, the individuation of each garment's electronic code represents the indication that makes it possible to assign any individual garment to its proper owner; the said boxes are therefore accordingly made with a removable base, which opens as soon as the garment has been identified.

The garment can therefore fall onto a conveyor belt beneath, that will for example convey it to a particular laundry bin which corresponds to the owner of that garment.

Referring to this well-established technology, the above-mentioned identification box is also equipped with means to handle the garments placed in the box; these means are supposed to operate only when a particular garment, which is in the box, is in such a position that the chip sewn inside the garment cannot be identified by the above-mentioned identification means.

Indeed, the operation of these handling means makes it possible to modify the position of the garment and therefore place the corresponding chip in a position in which it can be identified.

The solutions that have been chosen so far for handling the garments inside such an identification box consist on one hand in having actuators which are able to energetically shake the whole structure of the box, and with it the garments held within, and on the other hand in having inside the box itself some rotating arms or a nozzle distributing forced air blasts, which are able, the former to take mechanical action, the latter to take pneumatic action, on the garments that have to be identified.

The aim of this invention is to innovate in this well-established technology, with the result of a simplified structure in the whole garment identification system, lower implementation costs and a higher operational efficiency.

The idea on which this invention is based consisted in understanding that the very forced air blasts which were sometimes used in the past to change the position of the garments inside an identification box was actually also suitable for being advantageously used for the ejection of the garments from the box once they have been identified.

Accordingly, it is obvious that the system's box, according to the invention, has to be equipped with devices (preferably a considerably powerful fan) which are capable of giving the air contained in the box itself an energetic acceleration.

Actually, during the garment identification operation, these devices can usually remain inactive, and briefly become active —in order to shake the garment—only if the chip of that garment was initially not in a position to be identified by the relevant identification devices.

But once the identification has occurred, these same devices can become operational again and remain operational as long as necessary in order for the air disturbance generated by them to “push” the garment towards the top and towards the outside of the box itself.

Concerning this last point, it should be noted that the adoption of the technology described above requires the modification of the identification box structure, as well as of the way in which the outgoing garments get to the different collection bins.

The box made in connection with the system, according to this invention, has a large opening at the top which allows the subsequent garments, pushed in an appropriate way by the said strong air blasts, to flow upwards out of the box rather than downwards, as happens in the previously used identification and sorting boxes.

It is therefore clear that the system according to this invention does not require the use of those conveyor belts onto which the previously used boxes used to unload, by force of gravity, the garmerits that had just been identified.

Precisely, in order to “force” the identified garments out through the said upper opening of the identification and sorting box, there is, below the opening, a base with a grating and a powerful fan below.

It is accordingly easy to understand that the powerful air blast generated by the fan blows into the inside of the box thanks to the grating in the base, blowing straight at the garment that has just been identified and ejecting it out of the box through the said upper opening specially provided.

With this system, the garments conveyed towards the top of the box enter a large conveying and unloading pipe and pass through it rapidly, again thanks to the “pneumatic” upthrust due to the said fan associated with the base of the box.

In detail, this pipe appears like an overturned “U”, with a first vertical rising section (which each garment enters just after having been ejected from the identification box), which takes the garments up, a central horizontal section, which takes the garments away from the identification box, and a final vertical section, facing downwards, from which the garments can easily drop, by force of gravity, into the corresponding laundry bin which has been placed below.

In order to further increase the practical and versatile aspect of the new system in question, the said conveying pipe is able to swivel, using as an axis its own vertical rising section, the one joined onto the said identification box.

This possibility for the pipe to swivel allows a fast variation of its own position and therefore also a variation of the point in which it unloads the different garments.

It is therefore possible to prepare a certain number of laundry bins behind the identification box and, taking advantage of the said swiveling capacity of the unloading pipe, to convey the outgoing garments selectively to one or the other of these bins.

Finally, it is important to note that the sorting and identification box used according to this invention has recourse to a base which tips downwards and frees a falling section for the garments found within.

In detail, the “removal” of this base is activated when a garment placed in the identification box cannot be identified, for example because of the accidental loss of the corresponding chip.

In such a case, it is indeed important to prevent an unidentified garment from being sent on to the following sorting phase; this is why the said opening in the identification box base makes it possible for this garment to fall, by force of gravity, into a bin reserved precisely for collecting garments that cannot be identified.

For major clarity the description of the invention continues with reference to the enclosed drawings, intended for purposes of illustration and not in a limiting sense, where:

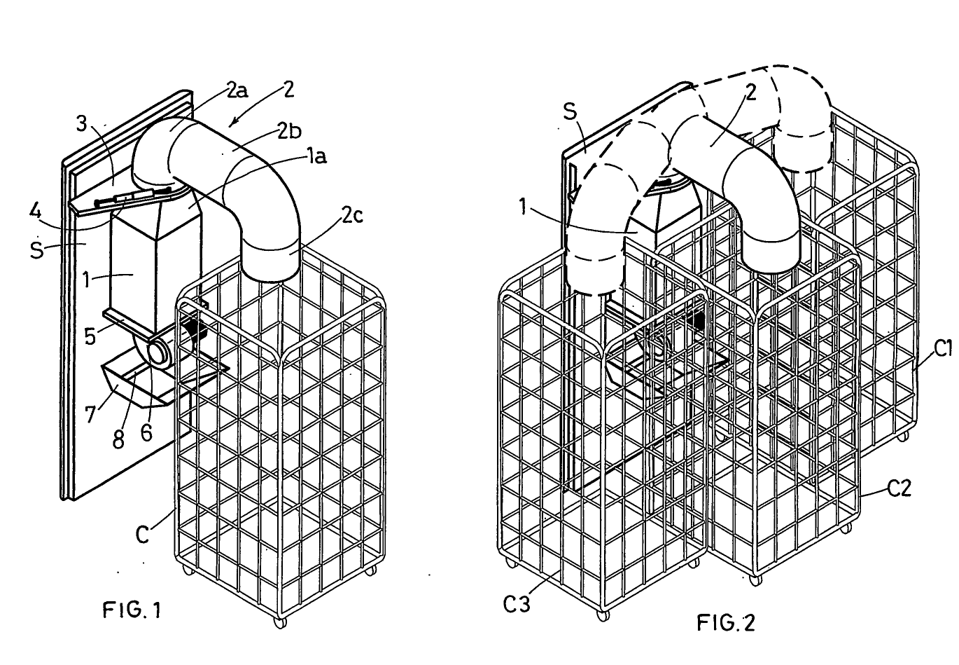

FIG. 1 is an axonometric representation of the device according to the invention;

FIG. 2 is similar to the previous figure, but shows the swiveling capacity given to the corresponding conveying pipe for garments that have previously been identified.

With reference to these figures, the said system includes a vertical support structure (S) supporting a box (1) for the identification and sorting of single garments or laundry items provided with an identification chip; the loading of the said box (1) occurs through a window (not shown on the enclosed drawings) cut out of the said vertical support wall (S).

This box (1) usually bears within the appropriate identification devices that are able to read the chips sewn onto the garments that are loaded into this box by being inserted one by one through the said window.

At the top, the said box (1) ends with a truncated pyramid-shaped section (1a), joined with a hermetic seal to the straight ascending section (2a) of a large conveying pipe (2), with the interposition of a horizontal plate (3) protruding from the back of the above-mentioned vertical support structure (S).

In the preferred embodiment, the above-mentioned pipe (2) has the profile of an overturned “U” which includes, in addition to the above-mentioned vertical ascending section (2a), an intermediate horizontal section (2b) and a vertical descending section (2c); this pipe also preferably has the capacity of swiveling around the longitudinal axis of its own vertical ascending section (2a), properly anchored to the above-mentioned horizontal plate (3).

The swiveling of the said pipe (2), as shown in FIG. 2, is provided thanks to an opposed pair of horizontal axed jacks (4) attached at one extremity to the said horizontal plate (3) and at the opposite extremity to the outside of the base of the said pipe (2)'s vertical ascending section (2a).

In the lower part, the said box (1) is closed by a base with a grating structure (5), below which a powerful fan is attached (6), facing in such a way that the air blast it produces can enter the box (1) through the said grating in the base (5).

Now, as explained earlier, the said fan (6) can be used with a twofold purpose.

On one hand, to briefly shake a garment in the box (1) when its chip is placed in such a position that it is impossible for the said identification devices placed in the box itself to read it; but also, on the other hand, to energetically push the garment itself towards the said conveying pipe placed above (2).

Needless to say that in the second case, the fan (6) has to operate for a longer period of time than when it is used only for shaking a garment.

Regarding this point, it has to be noted that FIG. 1 shows the event of the said system connected to a single laundry collection bin (C); in this case, the conveying pipe (2) can obviously remain in a fixed position by which its vertical descending section (2b) is perfectly centered above the laundry bin itself.

FIG. 2, on the other hand, shows the connection of the same system to three different laundry collection bins (C1, C2, C3); in this case, the conveying pipe (2) has to be directed to one of these three bins, depending on the bin to which the garments ejected from the box are destined.

Although on the enclosed figures the said base (5) of the box (1) is always shown in its horizontal, closed position, it has to be reminded that it also has the capacity of tipping downwards (operated by appropriate actuators not shown on the enclosed figures), to enable the falling by force of gravity of those garments that have previously been inserted in the box itself (1) and that were not identified.

More in detail, every single unidentified garment that falls from the box (1) falls onto an underlying hopper (7) that enables the subsequent conveying towards a opening for returns (8)—cut out of the said support structure (S) below the above-mentioned loading window—where it can be retrieved by the owner himself who has just inserted it in the box itself.

1. System for the identification and the sorting in a predetermined order of single garments or laundry items of the sort that uses a box (1) suitable for reading chips sewn on garments introduced inside the box attached to a support structure (S) that includes a window for loading the subsequent garments characterized by the fact that the said box (1) has a tapered profile at the top (1a) joined with a hermetic seal to the straight ascending section (2a) of a large conveying pipe (2), while underneath it has a base (5) with a grating structure, associated with a device (6) suitable for blowing into the box itself (1) a powerful air blast which can give the garments found in the box an upthrust that allows them to enter the above-mentioned conveying pipe (2) placed above and to pass through its whole length until the outlet segment.

2. system according to claim 1, characterized by the fact that the said conveying pipe (2) has the profile of an overturned “U” which includes, in addition to the above-mentioned vertical ascending section (2a), an intermediate horizontal section (2b) and a vertical descending section (2c).

3. System according to claim 1, characterized by the fact of having in an intermediate position between the said tapered top (1a) of the box (1) and the said vertical ascending section (2a) of the conveying pipe (2), a horizontal plate (3) that protrudes from the said structure (S) and is used for supporting the box (1).

4. System according to claim 1, characterized by the fact that the said conveying pipe (2) has the capacity of swiveling around the longitudinal axis of its own vertical ascending section (2a).

5. System according to claim 4, characterized by the fact that the swiveling of the said conveying pipe (2)is performed thanks to appropriate actuators (4).

6. System according to claim 5, characterized by the fact that the said actuators consist of an opposed pair of jacks (4) placed in an appropriate way between the said pipe(2)'s vertical ascending section (2a) and the horizontal plate (3) attached to the support structure (S).

7. System according to claim 1, characterized by the fact that the above-mentioned device associated with the grating base (5) and in charge of producing a powerful air blast and of blowing it into the box (1) consists of a fan (6) oriented in the necessary direction.

8. System according to claim 1, characterized by the fact that the above-mentioned grating base (5) operates thanks to suitable actuators which are alternately able to remove it from its closed position in order to open the base of the box (1), and then to pull it back in the same closed position.

9. System according to claim 8, characterized by the fact of supplying, below the said box (1), a hopper (7) for the purpose of receiving unidentified garments that fall, by force of gravity, out of the box itself (1) when the said base (5) is not in its closed position, the said hopper (7) is able to convey the garments towards a opening for returns (8), which is preferably cut out of the said support structure (S) of the box (1), below the above-mentioned loading window.
